(19) United States
(12) Patent Application Publication
(10) Pub. No.: US 2024/0126281 A1
(43) Pub. Date: Apr. 18, 2024

(54) REMOTE ASSISTANCE DEVICE AND STORAGE MEDIUM

(71) Applicant: DENSO CORPORATION, Kariya-city (JP)

(72) Inventors: Toru NAGURA, Kariya-city (JP); Yasuhiro HIRAYAMA, Kariya-city (JP)

(21) Appl. No.: 18/399,351

(22) Filed: Dec. 28, 2023

Related U.S. Application Data
(63) Continuation of application No. PCT/JP2022/017831, filed on Apr. 14, 2022.

(30) Foreign Application Priority Data
Jul. 2, 2021 (JP) 2021-111082

(51) Int. Cl. G05D 1/227; G05D 1/222; G05D 109/10

(52) U.S. Cl. CPC G05D 1/227; G05D 1/222; G05D 2109/10

(57) ABSTRACT

A remote assistance device includes a prediction unit that predicts an assistance provision probability that assistance for a vehicle will be necessary and a priority of the necessary assistance, which are associated with assistance contents of point information, based on a travel route including assistance points and the location information on the assistance points, and a reservation unit that determines whether a reservation for assistance by an operator is necessary based on the assistance provision probability and the priority, and sets, if the reservation is necessary, a reservation for assistance for not assigning an assistance task to the operator even when a low-priority assistance request is newly made while the reservation is held.

### CROSS-REFERENCE TO RELATED APPLICATION

The present application is based on and claims the benefit of priority from earlier Japanese Patent Application No. 2021-111082 filed on Jul. 2, 2021, the description of which is incorporated herein by reference.

### BACKGROUND

### Technical Field

The present disclosure relates to a remote assistance device and a remote assistance program.

### Related Art

Techniques concerning remote assistance for vehicles have been disclosed. For example, a technique is disclosed which can perform remote assistance for vehicles at appropriate timings by an operator.

### SUMMARY

An aspect of the present disclosure provides a remote assistance device, including: a prediction unit that predicts an assistance provision probability that assistance for a vehicle will be necessary and a priority of the necessary assistance, which are associated with assistance contents of point information, based on a travel route including assistance points and the location information on the assistance points; and a reservation unit that determines whether a reservation for assistance by an operator is necessary based on the assistance provision probability and the priority, and sets, if the reservation is necessary, a reservation for assistance for not assigning an assistance task to the operator even when a low-priority assistance request is newly made while the reservation is held.

### BRIEF DESCRIPTION OF THE DRAWINGS

In the accompanying drawings:

FIG. 1A is a diagram illustrating a case of a reservation and a response to a request for assistance when the reservation has been made;

FIG. 18 is a diagram illustrating a case of a reservation and a response to a request for assistance when the reservation has been made;

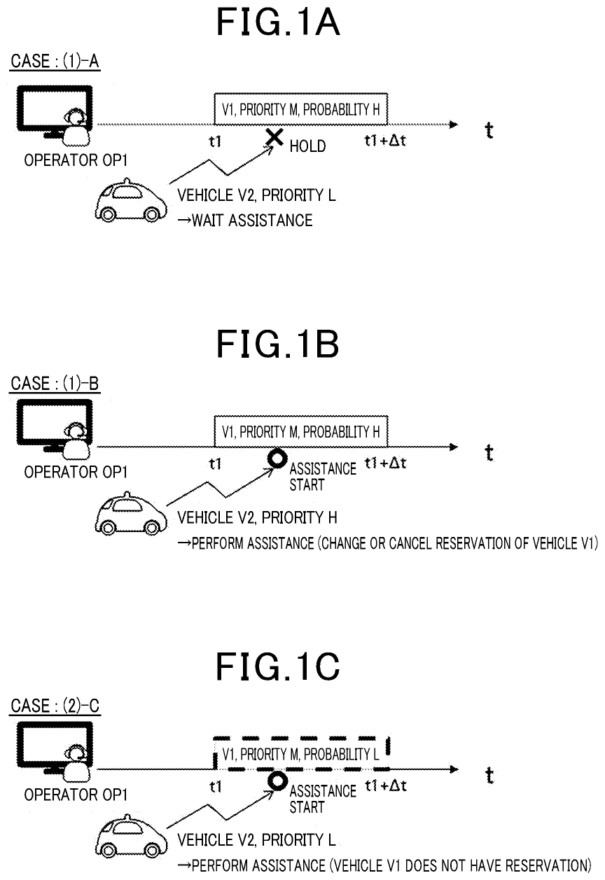

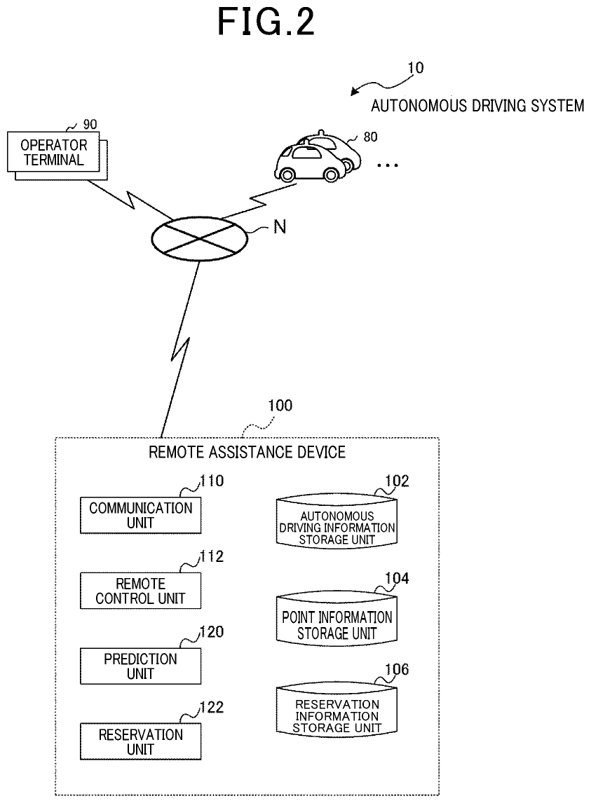

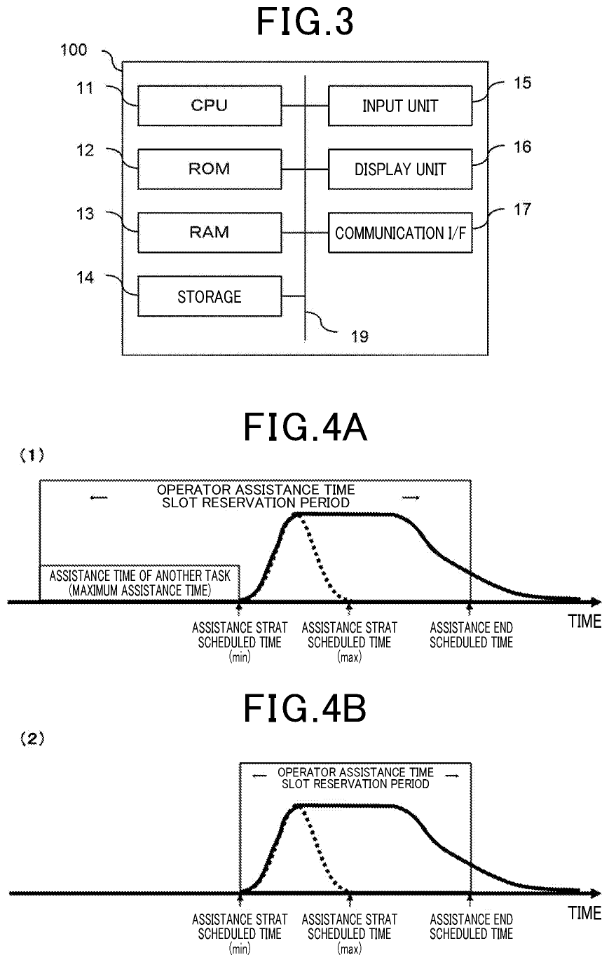

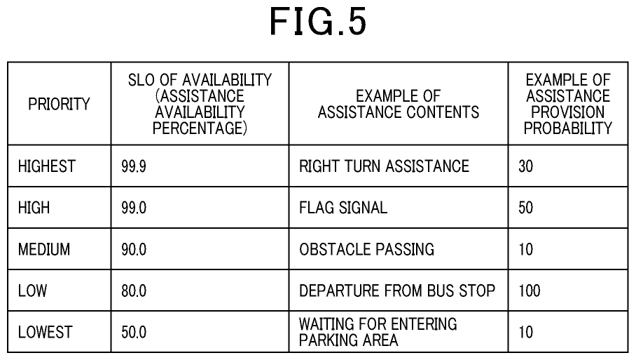

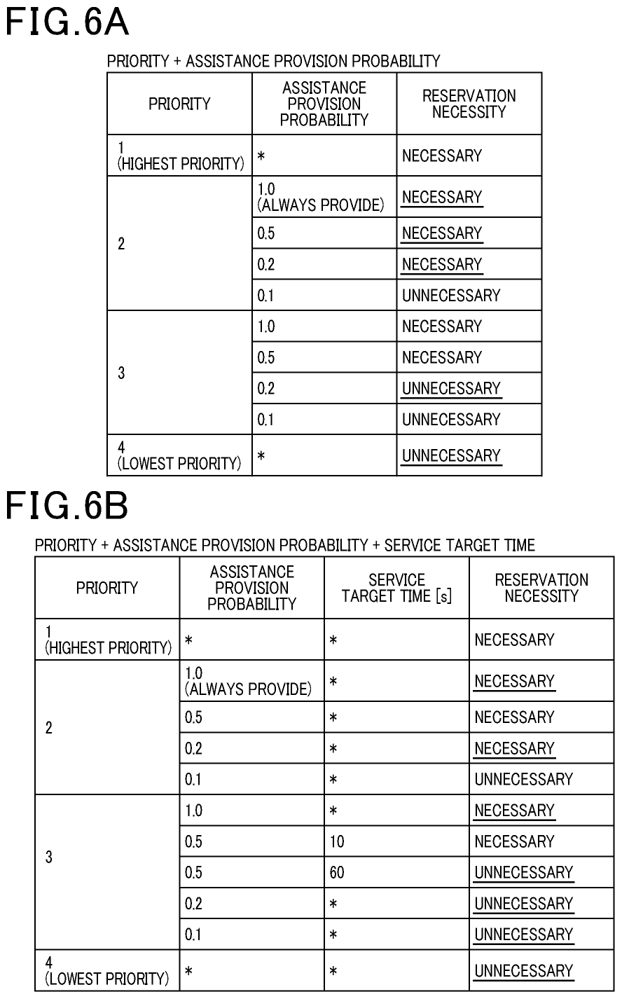

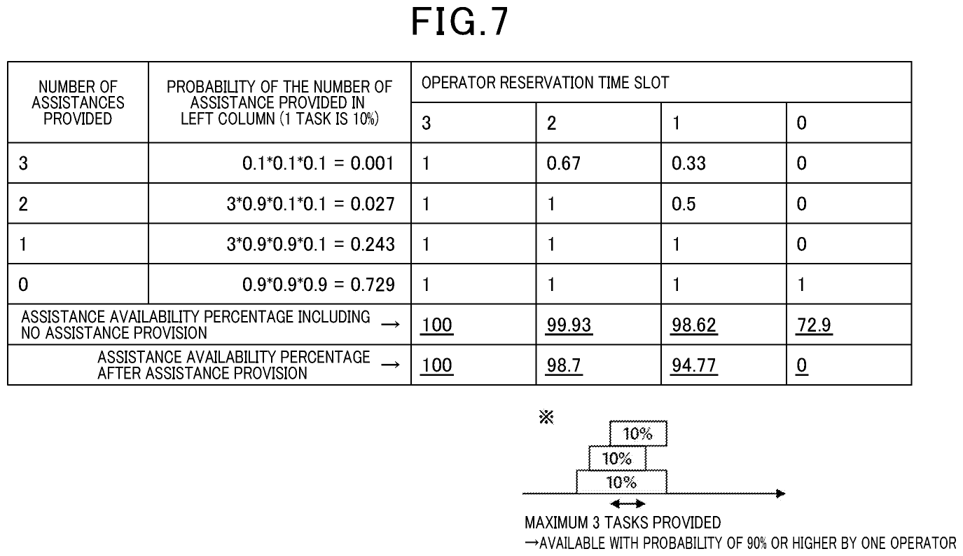

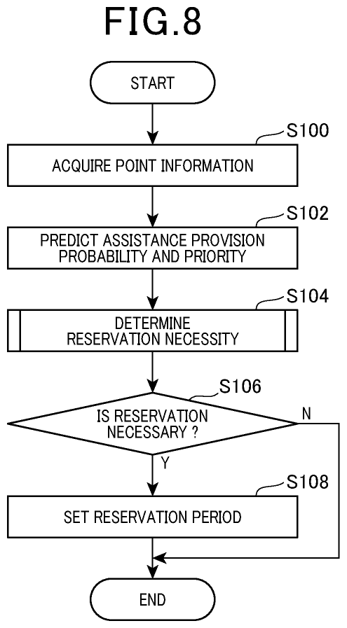

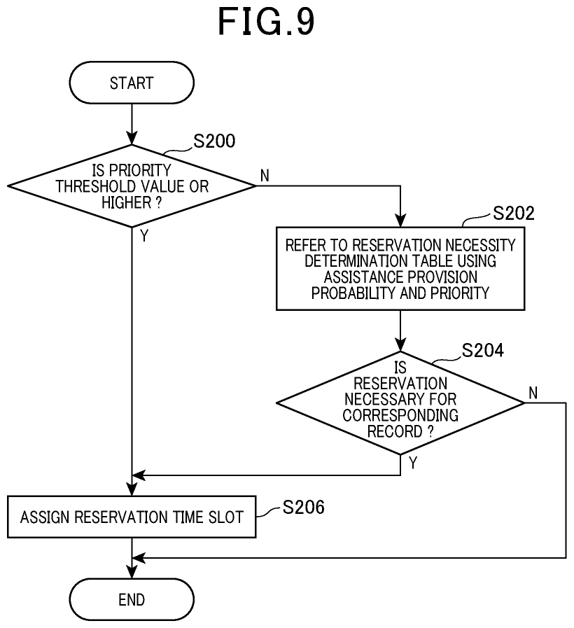

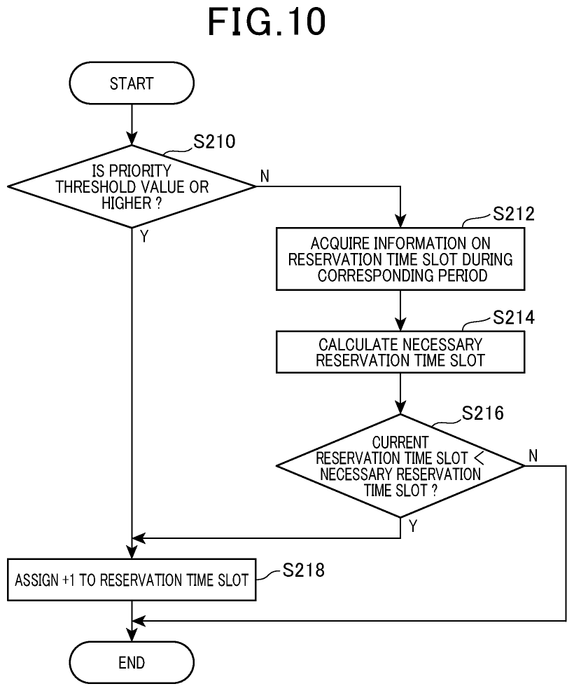

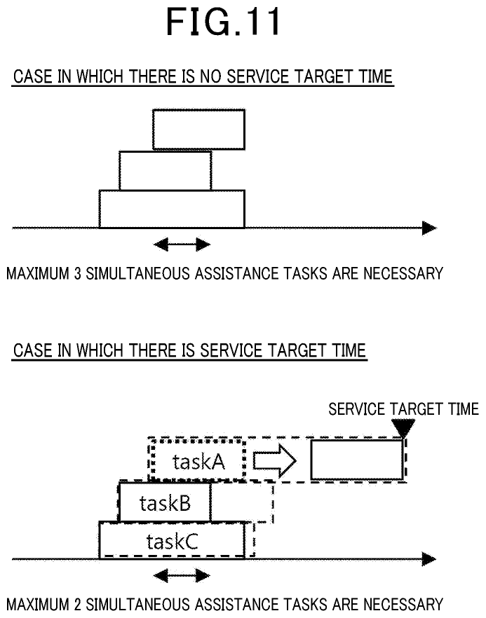

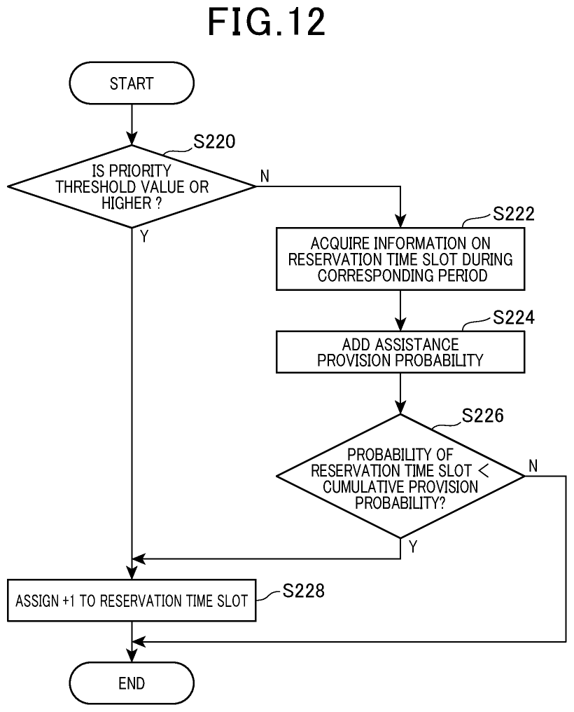

FIG. 1C is a diagram illustrating a case of a reservation and a response to a request for assistance when the reservation has been made;

FIG. 2 is a block diagram illustrating a configuration of an autonomous driving system according to an embodiment of the present disclosure;

FIG. 3 is a block diagram illustrating a hardware configuration of a remote assistance device;

FIG. 4A is a diagram illustrating an example of setting of a reservation period;

FIG. 4B is a diagram illustrating an example of setting of a reservation period;

FIG. 5 is an example of a reservation necessity determination table concerning an assistance provision probability and a priority;

FIG. 6A is a diagram of a table showing threshold values for combinations based on a rule;

FIG. 6B is a diagram of a table showing threshold values for combinations based on a rule;

FIG. 7 is a diagram illustrating a calculation example of assistance availability percentage;

FIG. 8 is a flowchart illustrating a reservation process according to the embodiment of the present disclosure;

FIG. 9 illustrates a determination process routine for reservation necessity using, as a reference, a threshold value of a combination of a priority and an assistance provision probability;

FIG. 10 illustrates a determination process routine in a case in which an operator reservation time slot which meets the assistance availability percentage is calculated;

FIG. 11 is an example of a case in which a reservation time slot is deleted due to delaying an assistance start timing by service target time; and

FIG. 12 illustrates a determination process routine in a case in which the sum of the assistance provision probabilities is greater than that of a reservation time slot.

### DETAILED DESCRIPTION OF THE PREFERRED EMBODIMENTS

Techniques concerning remote assistance for vehicles have been disclosed.

For example, a technique is disclosed which can perform remote assistance for vehicles at appropriate timings by an operator (refer to JP-A-2019-160146). According to this technique, in a remote assistance system that performs remote assistance for vehicles, a route planning unit specifies a route on which a vehicle reaches a destination via assistance points at which remote assistance is performed for the vehicle. A prediction unit predicts timings at which assistance for operation of the vehicle will be started by an operator, based on the scheduled time at which the vehicle reaches the assistance points included in the specified route.

However, detailed studies by the inventor found a problem that the remote assistance is not necessarily required at the assistance point at the predicted timing. Furthermore, the inventor found a problem that when no assistance needs to be provided, the operation prepared by the operator is wasted, and a situation in which the operator has no vacant time is caused. In addition, for example, there is a problem that if a new assistance request is made at the timing at which the operator has no vacant time, start of assistance is delayed.

The present disclosure provides a remote assistance device and a remote assistance program which can perform smooth travel with remote assistance.

Hereinafter, an embodiment of the present disclosure will be described with reference to the drawings.

An overview of the embodiment of the present disclosure will be described. In the present embodiment, to solve the above problem, a reservation is made for assistance by an operator. A remote assistance device, which is an autonomous driving center, calculates and stores point information such as assistance contents, assistance time period, and a provision frequency of remote assistance at an assistance point on a travel route and predicts a priority and an assistance provision probability of the remote assistance based on the location information. Then, the assistance by the operator is reserved depending on the prediction result. While the reservation is held, when a low-priority assistance request is newly made, an assistance task is not assigned to the operator. Hence, since start of assistance in responding to the assistance request having a high degree of necessity is not delayed, safety increases, whereby smooth travel of the vehicle can be performed.

A typical example of reservation will be described. FIG. 1A to FIG. 1C are diagrams illustrating cases of a reservation and a response to a request for assistance when a reservation has already been made. Regarding a reservation for assistance, (1) illustrates a case in which a reservation has been made, and (2) illustrates a case in which no reservation has been made. In (1), since provision of assistance, whose priority is medium, for a vehicle V1 is predicted with a high probability (assistance provision probability), a reservation has been made. In (2), since provision of assistance, whose priority is medium, for the vehicle V1 is predicted with a low probability, no reservation has been made. Next, after the determination whether a reservation has been made in the above (1) and (2), responses to a new request for assistance can be divided into cases A, B, C. A is a case in which a low-priority assistance request is made by vehicle V2 in (1). In this case, since the priority of the reservation that has already been made is higher than the priority of the newly-made assistance request, assistance for the vehicle V2 is made to wait (case (1)-A). B is a case in which a high-priority assistance request is made by the vehicle V2 in (1). In this case, since the priority of the newly-made assistance request is higher than the priority of the reservation that has already been made, assistance is provided to the vehicle V2, and the reservation of the vehicle V1 is changed or canceled (case (1)-B). C is a case in which a low-priority assistance request is made by the vehicle V2 in (2). In this case, since no reservation has been made, assistance is provided to the vehicle V2 (case (2)-C). As described above, acceptability of interruption of another assistance task is controlled depending on the reservation.

Hereinbefore, the overview of a method of the present embodiment has been described. Hereinafter, a configuration and functions of the present embodiment will be described.

### [Configuration of Autonomous Driving System]

FIG. 2 is a block diagram illustrating a configuration of an autonomous driving system 10 according to the embodiment of the present disclosure. As illustrated in FIG. 2, in the autonomous driving system 10, a plurality of vehicles 80, an operator terminal 90 operated by an operator, and a remote assistance device 100 are connected via a network N. It is noted that since configurations of the vehicle 80 and the operator terminal 90 may be similar to that of a typical method of remote assistance for vehicles disclosed in JP-A-2019-160146 or the like, specific description thereof is omitted.

FIG. 3 is a block diagram illustrating a hardware configuration of the remote assistance device 100. As illustrated in FIG. 3, the remote assistance device 100 has a CPU (Central Processing Unit) 11, a ROM (Read Only Memory) 12, a RAM (Random Access Memory) 13, a storage 14, an input unit 15, a display interface (I/F) 16, and a communication interface (I/F) 17. The components are communicably connected with each other via a bus 19.

The CPU 11 is a central processing unit (computer), and executes various programs including a remote assistance program and controls each unit. That is, the CPU 11 reads the program from the ROM 12 or the storage 14 and executes the program using the RAM 13 as a work area. The CPU 11 performs control of the above components and various types of arithmetic processing according to the program stored in the ROM 12 (storage medium) or the storage (storage medium) 14. In the present embodiment, the ROM 12 or the storage 14 stores the remote assistance program.

The ROM 12 stores various programs and various data. The RAM 13 serves as a work area to temporarily store programs and data. The storage 14 is configured by a storage device such as an HDD (Hard Disk Drive), an SSD (Solid State Drive), or the like, and stores various programs including an operating system and various data.

The input unit 15 includes a pointing device such as a mouse and a keyboard and is used to perform various inputs.

The display interface 16 is, for example, a liquid crystal display and displays various types of information. The display interface 16 may employ a touch panel to function as the input unit 15.

The communication interface 17 is an interface for communicating with other devices such as a terminal and uses a standard, for example, Ethernet (registered trademark), FDDI, Wi-Fi (registered trademark), Bluetooth (registered trademark), or a cellular communication system. Hereinbefore, an example of the hardware configuration of the remote assistance device 100 has been described.

Hereinafter, a functional configuration of the remote assistance device 100 will be described.

The remote assistance device 100 includes an autonomous driving information storage unit 102, a point information storage unit 104, a reservation information storage unit 106, a communication unit 110, a remote control unit 112, a prediction unit 120, and a reservation unit 122.

The autonomous driving information storage unit 102 stores vehicle information concerning remote assistance for vehicles, a route plan (travel route), a travel plan, operator information, assistance task information, and the like.

The point information storage unit 104 stores point information on each assistance point. The point information includes assistance contents, an assistance time period, service target time, and the like of each point. The assistance contents are associated with an assistance provision probability and a priority. The assistance provision probability is based on probability reference information including past statistical information. The probability reference information includes assistance logs of other vehicles. The assistance log is information such as assistance contents performed at the point, an assistance time period, and the like. The priority is set to levels 1 to 4 for each of the assistance contents. For example, the highest priority is set to level 1 that is the highest level, and the lowest priority is set to level 4 that is the lowest level. The highest level is an example of a high level of the present disclosure, which is a predetermined level or higher. The lowest level is an example of a low level of the present disclosure, which is a predetermined level or lower. It is noted that the assistance provision probability is a probability that assistance will be necessary. The priority is the degree of importance of the necessary assistance. An example of a case in which the assistance provision probability increases will be described. For example, in intersection right turn assistance, when an oncoming vehicle is approaching, if a predicted path of the vehicle entering an intersection and a predicted path of an own vehicle overlap with each other, the assistance provision probability is set to be high. In addition, in passing assistance, on a road on which many vehicles are waiting for entering a parking area or are parked, the assistance provision probability is set to be high. In addition, in bus stop and start assistance (safety confirmation of the vehicle), when there are passengers getting on and off, the assistance provision probability is set to be high. As described above, information on a situation of the assistance point, which is not statistical information, is also used to determine necessity of a reservation.

The reservation information storage unit 106 stores reservation information (reservation time slot (reservation frame), and reservation period) set by the reservation unit 122. In addition, the reservation information storage unit 106 stores a set reference (e.g., a threshold value) corresponding to the assistance provision probability and the priority for determining whether a reservation is necessary. An example of application of the reference will be described referring to the reservation unit 122.

The communication unit 110 communicates with the vehicle 80 and the operator terminal 90 via the network N to transmit and receive required information.

The remote control unit 112 performs the overall control concerning remote assistance. This control concerning remote assistance includes route planning of the vehicle 80, preparation of a travel plan, assignment of assistance tasks to operators, and the like. It is assumed not only that the route planning is performed by the remote control unit 112 but also that functions of the route planning are provided as the following three cases: (1) provided to the remote assistance device 100 or another device in the autonomous driving system 10, (2) provided to a cooperating traffic control system, and (3) provided to a cooperating vehicle. In cases (2) and (3), the autonomous driving system 10 does not perform the route planning, and the functions are provided to acquire route planning information. It is noted that since other various functions may be similar to those of JP-A-2019-160146, specific description of which is omitted.

The prediction unit 120 predicts the assistance provision probability that assistance for the vehicle will be necessary and the priority of the necessary assistance, which are associated with the assistance contents of the point information. The prediction is performed based on, for example, the travel route including the assistance points and the location information concerning the assistance points. The prediction can be performed, for example, for each of the assistance points on the travel route, by referring to the point information on the assistance point and the statistical information to acquire the assistance provision probability and the priority of each of the assistance contents. For example, the assistance provision probability and the priority of an assistance content may be predicted by referring to the past statistical information and the like in the autonomous driving information storage unit 102 to extract the predicted assistance content on the travel route. It is noted that when the assistance provision probability changes with time, the assistance provision probability corresponding to the time may be estimated using scheduled arrival time at the assistance point in the travel plan.

The reservation unit 122 determines whether a reservation for assistance by the operator is necessary based on the assistance provision probability and the priority and sets the reservation for assistance. To determine necessity of a reservation, the reference stored in the reservation information storage unit 106 is used. Hereinafter, concerning a specific example of a reservation process, the reservation period and the determination of necessity of a reservation will be described.

The reservation period will be described. Reservation by the reservation unit 122 is performed, for example, when travel of the vehicle 80 is planned. The reservation unit 122 refers to a table of the assistance provision probability and the priority, and the threshold value. After the necessity of a reservation for assistance is determined, if determining to make a reservation, the reservation unit 122 sets a reservation period. FIG. 4A and FIG. 4B are diagrams illustrating an example of setting of a reservation period. Regarding the reservation period (operator assistance time slot reservation period), FIG. 4A illustrates (1) a case of considering assistance time periods of other tasks (i.e., a case including waiting time until assistance starts), and FIG. 4B illustrates (2) a case of not considering assistance time periods of other tasks. Regarding the reservation period, it is assumed that using an assistance start scheduled time (min), which is estimated from scheduled arrival time, as a reference of a start point (or using an arbitrary position up to max as the reference of the start point), an assistance time period associated with the assistance contents is set.

Referring to FIGS. 4A and 4B, an example of reservation updating performed when assistance of another assistance task is newly provided will be described. With respect to the reserved assistance of FIG. 4A (1), if the priority of the provided assistance of another task is the same or higher, the reservation contents are changed from the reserved assistance to the provided assistance. This is because even if the priority is the same, it is assumed that a target for which it is determined that assistance is necessary has to precede a target for which assistance may be necessary. For the reserved assistance, the reservation is changed or canceled at the time after the provided assistance ends. In addition, when the assistance end scheduled time of the provided assistance is earlier than the assistance start scheduled time of the reserved assistance, the start time of the reservation period is changed to the assistance end scheduled time of the provided assistance. In the case of FIG. 4B (2), it is confirmed whether there is any reserved assistance whose reservation period overlaps with the assistance end scheduled time of the provided assistance of another task. If there is overlapping reserved assistance and the priority of the provided assistance is that of the reserved assistance or higher, the reservation contents are changed from the reserved assistance to the provided assistance. For the reserved assistance, the reservation is changed or canceled at the time after the provided assistance ends. If there is no reserved assistance whose reservation period overlaps with the assistance end scheduled time of the provided assistance, the reservation is not updated. This is because it is considered that the reserved assistance is not affected, and it is appropriate to respond in order from the provided assistance to the reserved assistance.

A specific example of the determination of whether a reservation is necessary will be described. FIG. 5 is an example of a reservation necessity determination table concerning the assistance provision probability and the priority. In FIG. 5, in addition to the priority, the assistance contents, and the assistance provision probability, an assistance availability percentage is indicated as an SLO (Service Level Objective) of availability. The assistance availability percentage is a requirement of a predetermined service level. Examples of alternatives of a specific method of determining whether a reservation is necessary include the following references (1) to (4). For each of the references, a threshold value may be set appropriately. (1) If the combination of the priority and the assistance provision probability exceeds a threshold value, it is determined that a reservation is acceptable. (2) An operator reservation time slot which meets the assistance availability percentage is calculated. One reservation time slot is assigned to one operator, and allocation in periods is managed during the reservation process. The number of operators to be allocated which can meet the assistance availability percentage can be calculated from the assistance provision probability and the reservation time slot. (3) When the priority is low to high (excluding the highest and the lowest), if the sum of the assistance provision probabilities is higher than that of the reservation time slot, it is determined that a reservation is acceptable. For example, if the assistance provision probability is 30%, up to three assistance tasks can be accepted for one reservation time slot. (4) When the priority is low to high, it is determined that a reservation is acceptable depending on the assistance provision probability. For example, if the assistance provision probability is 30%, reservation time slot +1 is set with a probability of 0.3. Hereinafter, the above (1) and (2) will be described in detail.

A case in which the threshold value for the combination is used in the above (1) will be described. FIG. 6A and FIG. 6 B are tables showing threshold values for combinations based on a rule. FIG. 6A shows a determination reference of the necessity of a reservation considering the priority and the assistance provision probability. FIG. 6B shows a determination reference of the necessity of a reservation considering the priority, the assistance provision probability, and the service target time. In FIG. 6B, the determination reference is set so that, for example, when the priority is 2, and the assistance provision probability is 0.2, it is determined that a reservation is necessary, and when the priority is 2, and the assistance provision probability is 0.1, it is determined that no reservation is necessary. FIG. 6A illustrates a case in which the service target time is set for the assistance contents. For example, regarding the assistance contents whose priority is 3, assistance provision probability is 0.5, and service target time is 10 s, it is determined that a reservation is necessary. Regarding the assistance contents whose service target time is 60 s, it is determined that no reservation is necessary. As described above, an acceptable length of waiting time is set by the service target time. It can be considered that as the service target time is shorter, the degree of importance is higher, and necessity of a reservation is higher. In addition, it can be considered that as the service target time is longer, the degree of importance is lower, whereby it is assumed that urgency is not required. Hence, even in cases of the same priority and assistance provision probability, necessity of a reservation is differentiated. The case in the above (1) illustrated in FIG. 6A and FIG. 6 B corresponds to a typical example of a reservation illustrated in FIG. 1.

The assistance availability percentage in the above (2) will be described. For example, the assistance availability percentage may be determined and set as a reference. The SLO of availability is set so that any of the following is 100% (It is noted that 100% is not set in the overall travel time period). [1] An assistance provision candidate including no provision of assistance. [2] The number of performed assistances after provision of assistance. [1] is calculated from a viewpoint of an operator (considering a case in which no assistance is provided). [2] is calculated from a viewpoint of the vehicle.

FIG. 7 is a diagram illustrating an example of calculating assistance availability percentage. A case will be described in which the operator reservation time slot which meets the assistance availability percentage is calculated. The example in FIG. 7 illustrates a case in which it is expected that three tasks whose priority level is medium is provided. A probability for each of the numbers of assistance provisions is determined using the assistance provision probability. The probability of the number of assistance provisions being 3 is the lowest, at 0.001. The probability of the number of assistance provisions being 0 is the highest, at 0.729. The probability and a sufficiency rate of the operator reservation time slot with respect to the number of assistance provisions determines the assistance availability percentage. In FIG. 5, since the requirement of the assistance availability percentage whose priority is medium is 90%, it can be understood that reserving one operator time slot meets the assistance availability percentage when no assistance is provided and after assistance is provided.

Next, functions of the remote assistance device 100 will be described. FIG. 8 is a flowchart illustrating a reservation process according to the embodiment of the present disclosure. The CPU 11 functions as the units of the remote assistance device 100 and performs the reservation process. The reservation process is performed when travel of the vehicle 80 is planned. For the reservation process, a travel route has been acquired.

In step S100, the CPU 11 acquires point information on assistance points of the travel route.

In step S102, the CPU 11 predicts the assistance provision probability of necessity of assistance for the vehicle and the priority of the required assistance, which are associated with the assistance contents of the point information. The prediction is performed based on the travel route including the assistance points and the location information concerning the assistance points. Hence, the assistance provision probability at the assistance point and the priority are predicted.

In step S104, the CPU 11 determines whether a reservation for assistance is necessary based on the predicted assistance provision probability and priority. The details of a determination process will be described later.

In step S106, if determining that a reservation is necessary in step S104, the CPU 11 proceeds to step S108, and if determining that no reservation is necessary, the CPU 11 ends the process.

In step S108, a reservation period for assistance by an operator is set. Regarding the reservation period, whether assistance time periods of other tasks are considered can be arbitrarily set. It is noted that after the reservation process, if another assistance task is provided, the reservation updating described above may be performed. When updating the reservation, the reservation is changed by shifting the reservation period or is canceled. Determination of whether to update the reservation may be performed based on the priority and the assistance provision probability as described with reference to FIG. 1. In addition, if no assistance task is provided during a given time period, the reservation may be canceled.

Next, the details of the determination whether a reservation is necessary in step S104 will be described. Since the cases of the above described (1) to (4) regarding the reference can be applied to the determination whether a reservation is necessary, each of the cases will be described. It is noted that since (3) and (4) can be deemed to be similar determination process routines for reservation necessity, only (3) will be described. It is noted that the determination process routine for reservation necessity may be performed for each of the assistance contents of the vehicle 80 in descending order of the priority.

FIG. 9 illustrates a determination process routine for reservation necessity using, as a reference, a threshold value of a combination of the priority and the assistance provision probability.

In step S200, the CPU 11 determines whether the priority is a threshold value or higher. If the priority is the threshold value or higher, the CPU 11 proceeds to step S206. If the priority is not the threshold value or higher, the CPU 11 proceeds to step S202. In the present embodiment, the threshold value of the priority is level 1, which is the highest level, or higher.

In step S202, the CPU 11 refers to the reservation necessity determination table, which is illustrated in FIG. 5, using the assistance provision probability and the priority predicted in step S102. It is noted that when the assistance contents include the service target time, the service target time is also used.

In step S204, the CPU 11 determines, in the reservation necessity determination table, whether the relevant record indicates that a reservation is necessary. If a reservation is necessary, the CPU 11 proceeds to step S206. If no reservation is necessary, the CPU 11 ends the process.

In step S206, the CPU 11 allocates the reservation time slot of the operator. Information on the reservation time slot is stored in the reservation information storage unit 106.

FIG. 10 illustrates a determination process routine in a case in which an operator reservation time slot which meets the assistance availability percentage is calculated.

In step S210, the CPU 11 determines whether the priority is a threshold value or higher. If the priority is the threshold value or higher, the CPU 11 proceeds to step S218. If the priority is not the threshold value or higher, the CPU 11 proceeds to step S212.

In step S212, the CPU 11 acquires information on the reservation time slot in the relevant period based on the scheduled arrival time.

In step S214, the CPU 11 calculates a necessary reservation time slot based on the assistance provision probability and the assistance availability percentage. As illustrated in the example in FIG. 7, the necessary reservation time slot may be calculated.

In step S216, the CPU 11 determines whether the necessary reservation time slot is longer than a current reservation time slot. If the reservation time slot is longer, the CPU 11 proceeds to step S218. If the reservation time slot is not longer, the CPU 11 ends the process.

In step S218, the CPU 11 allocates, as +1, the reservation time slot of the operator in the relevant period. Information on the reservation time slot is stored in the reservation information storage unit 106. Performing the determination process for reservation necessity for each of the assistance contents can exhaustively determine the necessary reservation time slot. In addition, at the assistance point, an appropriate reservation time slot assumed to be necessary is allocated.

It is noted that in the determination in step S216, the reservation time slot may be deleted considering the service target time. FIG. 11 is an example of a case in which the reservation time slot is deleted due to delaying the assistance start timing by the service target time. Regarding task A (assumed assistance contents), since the service target time is long, the reservation time slot can be deleted by shifting the relevant period. When there is no service target time, up to three task simultaneous assistances are required, whereby there is a risk that waiting time is caused. However, when there is service target time, up to two task simultaneous assistance can be substituted, whereby the risk that waiting time is caused can be eliminated.

FIG. 12 illustrates a determination process routine in a case in which the sum of the assistance provision probabilities is greater than that of a reservation time slot.

In step S220, the CPU 11 determines whether the priority is a threshold value or higher. If the priority is the threshold value or higher, the CPU 11 proceeds to step S226. If the priority is not the threshold value or higher, the CPU 11 proceeds to step S222.

In step S222, the CPU 11 acquires information on the reservation time slot in the relevant period based on the scheduled arrival time.

In step S224, the CPU 11 adds the assistance provision probabilities during the relevant period.

In step S226, the CPU 11 determines, during the relevant period, whether the cumulative provision probability after the addition is higher than the probability of the reservation time slot (the probability of the reservation time slot is 1). If the cumulative provision probability is higher, the CPU 11 proceeds to step S228. If the cumulative provision probabilities is not higher, the CPU 11 ends the process.

In step S228, the CPU 11 allocates, as +1, the reservation time slot of the operator in the relevant period. Information on the reservation time slot is stored in the reservation information storage unit 106. Performing the determination process for reservation necessity for each of the assistance contents can exhaustively determine the necessary reservation time slot. In addition, at the assistance point, an appropriate reservation time slot assumed to be necessary is allocated.

As described above, according to the remote assistance device 100 of the autonomous driving system 10 of the embodiment of the present disclosure, smooth travel can be performed with remote assistance.

The present disclosure is not limited to the above embodiments, and many variations and applications are possible without departing from the spirit of the present disclosure.

When the travel plan is changed, for example, when the travel route or the scheduled arrival time is changed, the reservation may be updated. If the travel route is changed, the assistance points and the assistance provision probability are also changed. Hence, when the travel route is changed, the result of the determination whether a reservation for assistance is made and the reservation period are updated. Thus, accuracy in predicting the result of the determination whether a reservation for assistance is made and the reservation period increases, thereby reducing delay of the start of assistance due to a new assistance request made at the timing at which an operator has no vacant time and waste of prepared operation by the operator. If the scheduled arrival time is changed due to the change of the travel plan or due to a traffic situation, the assistance start scheduled time is changed. Hence, when the change of the scheduled arrival time is detected, updating the reservation period can increase the accuracy in prediction. In addition, since accuracy of the scheduled arrival time increases as an assistance point is approached, the reservation may be periodically updated to increase accuracy in estimating the reservation period, whereby a reservation time slot is calculated more accurately.

In addition, although an embodiment has been described in which a program is previously installed, the program may be provided by being stored in a computer readable storage medium.

An aspect of the present disclosure provides a remote assistance device, including: a prediction unit that predicts an assistance provision probability that assistance for a vehicle will be necessary and a priority of the necessary assistance, which are associated with assistance contents of point information, based on a travel route including assistance points and the location information on the assistance points; and a reservation unit that determines whether a reservation for assistance by an operator is necessary based on the assistance provision probability and the priority, and sets, if the reservation is necessary, a reservation for assistance for not assigning an assistance task to the operator even when a low-priority assistance request is newly made while the reservation is held.

According to the remote assistance device and the remote assistance program of the present disclosure, smooth travel can be performed with remote assistance.

What is claimed is:

1. A remote assistance device, comprising:
a prediction unit that predicts an assistance provision probability that assistance for a vehicle will be necessary and a priority of the necessary assistance, which are associated with assistance contents of point information, based on a travel route including assistance points and the location information on the assistance points; and
a reservation unit that determines whether a reservation for assistance by an operator is necessary based on the assistance provision probability and the priority, and sets, if the reservation is necessary, a reservation for assistance for not assigning an assistance task to the operator even when a low-priority assistance request is newly made while the reservation is held.

2. The remote assistance device according to claim 1, wherein
levels are set to the assistance provision probability and the priority, the level that is a predetermined level or higher is defined as a high level, and the level that is a predetermined level or lower is defined as a low level, and
based on a predetermined reference,
if the priority is the high level, the reservation unit determines that a reservation is necessary,
if the priority is lower than the high level and is higher than the low level, the reservation unit determines that a reservation is necessary if the assistance provision probability is the high level, and
if the priority is the low level, the reservation unit determines that no reservation is necessary.

3. The remote assistance device according to claim 1, wherein
the reservation unit further uses a service target time concerning an acceptable length of waiting time to perform the determination.

4. The remote assistance device according to claim 1, wherein
the reservation unit sets, for the reservation for assistance, a reservation period based on an assistance start scheduled time and an assistance end scheduled time estimated from a scheduled arrival time.

5. The remote assistance device according to claim 4, wherein the reservation unit set the reservation period so as to include a waiting time until assistance starts at the assistance start scheduled time.

6. The remote assistance device according to claim 1, wherein
the reservation unit updates the reservation when the travel route or the scheduled arrival time is changed.

7. The remote assistance device according to claim 1, wherein
The assistance provision probability is based on probability reference information including past statistical information, and the probability reference information includes an assistance log of another vehicle.

8. The remote assistance device according to claim 1, wherein
the reservation unit updates the reservation depending on another provided assistance task.

9. A storage medium in which a remote assistance program is stored to cause a computer to execute processing, the processing comprising:
predicting an assistance provision probability that assistance for a vehicle will be necessary and a priority of the necessary assistance, which are associated with assistance contents of point information, based on a travel route including assistance points and the location information on the assistance points; and
determining whether a reservation for assistance by an operator is necessary based on the assistance provision probability and the priority, and setting, if the reservation is necessary, a reservation for assistance for not assigning an assistance task to the operator even when a low-priority assistance request is newly made while the reservation is held.
